(19) United States
(12) Patent Application Publication
(10) Pub. No.: US 2002/0088907 A1
(43) Pub. Date: Jul. 11, 2002

(54) Equipment support stand

(75) Inventor: Edward Phillips, Burbank, CA (US)

Correspondence Address: Michael A. Painter, Esq., Suite 850, 8484 Wilshire Boulevard, Beverly Hills, CA, 90211, US

(73) Assignee: MSE MATTHEWS STUDIO EQUIPMENT, INC.

(21) Appl. No.: 09/756,050

(22) Filed: Jan. 8, 2001

(51) Int. Cl. F16M 11/00

(52) U.S. Cl. 248/157; 248/177.1; 248/187.1; 248/431; 248/161

(57) ABSTRACT

An equipment support stand for mounting and positioning photographic, motion picture and video accessories and the like. A riser comprising a plurality of telescoping shafts is coupled to lower, center and upper support legs which, when activated, will position the riser vertically relative to the mounting surface. Each support leg is integral with a respective positioning sleeve, the center and upper positioning sleeves being rotatably coupled about the lower end of the riser. Each positioning sleeve includes at least one engagement surface which is adapted to interface with the adjacent positioning sleeve or sleeves. When engaged, each of the three support legs are angularly spaced from adjacent support legs by 120° of arc. The center positioning sleeve may be secured to the riser in the engaged position. In the closed state, the center and upper support legs may be rotated about the riser and be placed in a co-planar relationship with the lower support leg to facilitate storage and transport.

### BACKGROUND OF THE DISCLOSURE

1. Field of the Invention

The present invention generally relates to mechanical supporting apparatus, and more particularly, to an improved supporting apparatus used to positionally support photographic, motion picture and video accessories.

2. Prior Art

As the photographic, motion picture and television industries have evolved and developed, demand for equipment which is capable of enhancing the final product has increased. This is led to the use of accessories which are integral and necessary to the filming and/or recording of visual and audible images. These accessories are, for example, such items as light reflectors, filters and microphones. The effective use of these accessories requires that they be placed in precisely the correct location to permit optimum recording of visual images and/or sound.

The prior art illustrates numerous designs for apparatus used to vertically position photographic, motion picture and video accessories. The most basic design constitutes a plurality of supporting legs, typically in the form of a fixed tripod which is integral with a vertical riser. The photographic, motion picture and video accessories which are to be positioned are secured directly or indirectly at the upper end of the vertical riser. The inadequacies of this design are inherent in its structure. Since all support members are in a fixed position relative to each other and the riser, they cannot be adjusted to compensate for changing conditions which result from the mounting surface upon which the apparatus is used. For example, where cables or other obstruction of varying heights are present, the fixed relationship of the support legs obviate the ability to change the height of the supporting apparatus or the individual support legs to compensate for the environment. In addition, the inability to fold or otherwise collapse the stand renders the design inefficient for storage or transport.

Another design for an equipment support apparatus disclosed by the prior art utilizes a supporting tripod wherein each of the three support legs are independently rotatable about an equipment riser. Although the support legs may be placed in a co-planar position to thereby reduce the problems inherent in storage and in transporting same, the inability to efficiently lock the support legs in a stable position creates problems which are resolved by the present invention. In the prior art design, each of the support legs is required to be independently rotatable with respect to one another about the riser shaft. As a result, unless easily and accurately positioned with respect to one another, the positioning of the support legs will be unstable and create the possibility of damage to the supported equipment.

The most relevant design disclosed by the prior art is set forth in U.S. Pat. No. 5,871,185. The support stand disclosed in the '185 patent employs three rotatable support legs which, when activated, are adapted to vertically position a rise relative to the mounting surface. Each support leg is integral with the positioning sleeve which are rotatably coupled about the lower end of the riser. When engaged, each of the three support legs are angularly displaced from adjacent support legs by 120° of arc. The angular relationship is maintained when the upper positioning sleeve is urged upwardly along the riser to allow its coupled support leg to rest upon an elevated support or obstruction surface. However, a problem inherent in this design arises if the support stand is inadvertently jarred. This could occur since the center and upper positioning sleeves are not secured to the riser when the support legs are in the open position; a positioning sleeve could rotate about the riser causing the support stand to collapse.

The present invention resolves the problems inherent in the designs disclosed by the prior art. The present invention equipment support stand employs three support legs which are integral with respective positioning sleeves. The sleeves are coupled to a vertical riser and adapted to engage one another in a manner which will stabilize the support legs and accurately position them in relation to one another. To avoid movement of an intermediate positioning sleeve, a locking apparatus is incorporated into the riser and is adapted to engage the center positioning sleeve when it is in the open position. When engaged, the supporting legs may not be inadvertently moved from their supporting position without overcoming the force imposed by the locking apparatus on the center positioning sleeve. In addition, since the positioning sleeves determine the angular separation of each support leg relative to the others, the present invention design insures support stability while simultaneously resolving the problems inherent in storage and transport.

### SUMMARY OF THE INVENTION

The present invention comprises an improved equipment support stand used to secure and position photographic, motion picture and video accessories. The equipment to be mounted is directly or indirectly coupled to the upper end of a vertically oriented riser. A riser adapted to be positioned vertically with respect to the mounting surface is constructed of a plurality of annularly disposed, extendable telescoping shafts, each of which is independently lockable in a position relative to the radially adjacent shaft or shafts. The stand support is coupled to the lower end of the riser and comprises three support legs. Each support leg is integral with a positioning sleeve. The positioning sleeve adapted to be adjacent the mounting surface is secured to the riser. The remaining positioning sleeves are adapted to be rotatably coupled about the longitudinal axis of the riser. The positioning sleeves are positioned about the riser in axial abutment with one another.

The positioning sleeves each incorporate an engagement surface at one or both ends thereof which are adapted to interface with the engagement surface of an adjacent sleeve or sleeves. When in the open position, the support legs will be angularly spaced from each other by 120° of arc thereby forming a stable supporting means for maintaining the riser in a vertical position. A locking apparatus is secured to the riser adjacent the center positioning sleeve and is adapted to engage the positioning sleeve when the support legs are in the open position. When the locking apparatus engages the center positioning sleeve, its position cannot be changed unless the securing force of the locking apparatus is overcome. The support legs may be rotated relative to one another about the riser to place the support legs in a coplanar position for storage or transport.

It is therefore an object of the present invention to provide an improved equipment support stand for photographic, motion picture and television accessories.

It is another object of the present invention to provide an equipment support stand having a plurality of supporting legs which are rotatable relative to one another.

It is still another object of the present invention to provide an improved equipment support stand having supporting legs which are rotatable relative to one another which are securable at fixed angular intervals.

It is still yet another object of the present invention to provide an improved equipment support stand which is simple and inexpensive to fabricate.

It is still yet another object of the present invention to provide an improved equipment support stand which is simple to rapidly deploy for usage and to rapidly collapse for storage.

The novel features which are believed to be characteristic of the invention, both as to its organization and method of operation, together with further objectives and advantages thereof, will be better understood from the following description considered in connection with the accompanying drawing in which a presently preferred embodiment of the invention is illustrated by way of example. It is to be expressly understood, however, that the drawing is for the purpose of illustration and description only, and is not intended as a definition of the limits of the invention.

### BRIEF DESCRIPTION OF THE DRAWING

FIG. 1 is a front perspective view of the present invention equipment support stand.

FIG. 2 is a side elevation view of the present invention equipment support stand illustrating the support legs in a closed position.

FIG. 3 is a side elevation view of the center support leg and center positioning sleeve shown in FIG. 2.

FIG. 4 is an assembly view of the positioning sleeves disposed about the vertical riser shown in FIG. 1.

FIG. 5 is a partial cross-sectional view of the base shaft illustrating the locking apparatus for the center support leg taken through line 5-5 of FIG. 1.

FIG. 6 illustrates the present invention equipment support stand partially mounted upon an obstruction member.

### DESCRIPTION OF THE PRESENTLY PREFERRED EMBODIMENT

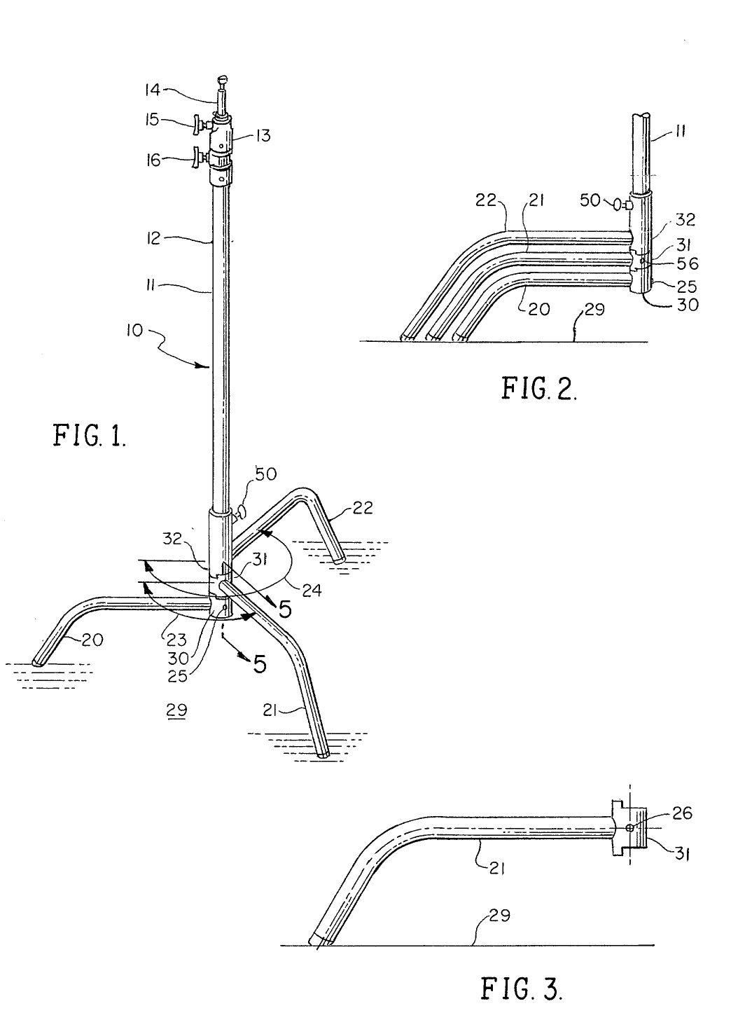

The present invention equipment support stand may be best seen by reference to FIG. 1 wherein the equipment support stand is generally designated by the reference numeral 10. Equipment support stand 10 is adapted for mounting and positioning photographic, motion picture and video accessories. Equipment support stand 10 comprises a vertically oriented riser 11 which is constructed of a cylindrical base shaft 12 and a plurality annularly disposed, telescoping extension shafts 13 and 14. Although the present invention is illustrated employing a riser 11 comprising three extendable shafts 12, 13 and 14, it is understood the scope of the present invention covers the use of either a single shaft or multiple telescoping shafts.

An objective of the present invention is to provide an equipment support stand which is used to mount or otherwise support photographic, motion picture and television accessories. The accessories are mounted or otherwise coupled to the upper extension shaft 14 by direct or indirect couplings (not shown). Extension shaft 14 may be elevated relative to shaft 13 and secured in place by a conventional locking clamp 15. In a like manner, shaft 13 may be elevated relative to base shaft 12 and be secured in place through the use of a conventional locking clamp 16.

Another objective of the present invention is to provide an equipment support stand having a plurality of supporting legs which are rotatable relative to one another to thereby provide an efficient structure for storage and transport. As can be seen in FIG. 1, the present invention equipment support stand 10 utilizes a tripod formed from independently rotatable support legs 20, 21 and 22. When in use, support legs 20, 21 and 22 are angularly separated from each other by 1200 of arc as illustrated by the angular references 23 and 24. As shown in FIG. 2, when closed for storage or transport, support legs 20, 21 and 22 lie in a coplanar relationship with one another.

The structural relationship between support legs 20, 21 and 22 may be best understood by reference to FIGS. 1-4, inclusive. As shown in FIGS. 1 and 2, lower positioning sleeve 30, center positioning sleeve 31 and upper positioning sleeve 32 are disposed about and concentric with base shaft 12. Center positioning sleeve 31 and upper positioning sleeve 32 are rotatable about base shaft 12. However, lower positioning sleeve 30 is secured to the lower terminus of base shaft 12 through the use of a fixed locking pin 25 or other conventional locking means such as a rivet or screw.

FIG. 3 illustrates center support leg 21 which typically comprises an articulated cylindrical shaft, one end being in contact with the ground or other supporting surface 29, the opposing end being integral with center positioning sleeve 31. Center positioning sleeve 31 is a cylindrical member adapted to be rotatable about base shaft 12. Aperture 26 is disposed through the wall of positioning sleeve 31. As will be described in detail hereinbelow, in order to meet an objective of the present invention, a locking apparatus secured within base shaft 12 provides a spring-loaded pin which permits center positioning sleeve 31 to be locked in place when in the open position as shown in FIG. 1 and FIG. 5.

Although lower supporting leg 20 is typically welded to lower positioning sleeve 30 to form a secure structure, it is understood the coupling between lower support leg 20 and lower positioning sleeve 30 may be implemented by other conventional means. As can be seen in FIG. 1 and FIG. 2, center support leg 21 and upper support leg 22 are respectively coupled to center positioning sleeve 31 and upper positioning sleeve 32, respectively, in the same manner as shown in FIG. 3.

As stated, it is an objective of the present invention to provide support legs which are rotatable between the open, operating condition shown in FIG. 1 and the storage condition shown in FIG. 2. The structure of the positioning sleeves 30, 31 and 32 provide the structure to meet the defined objective.

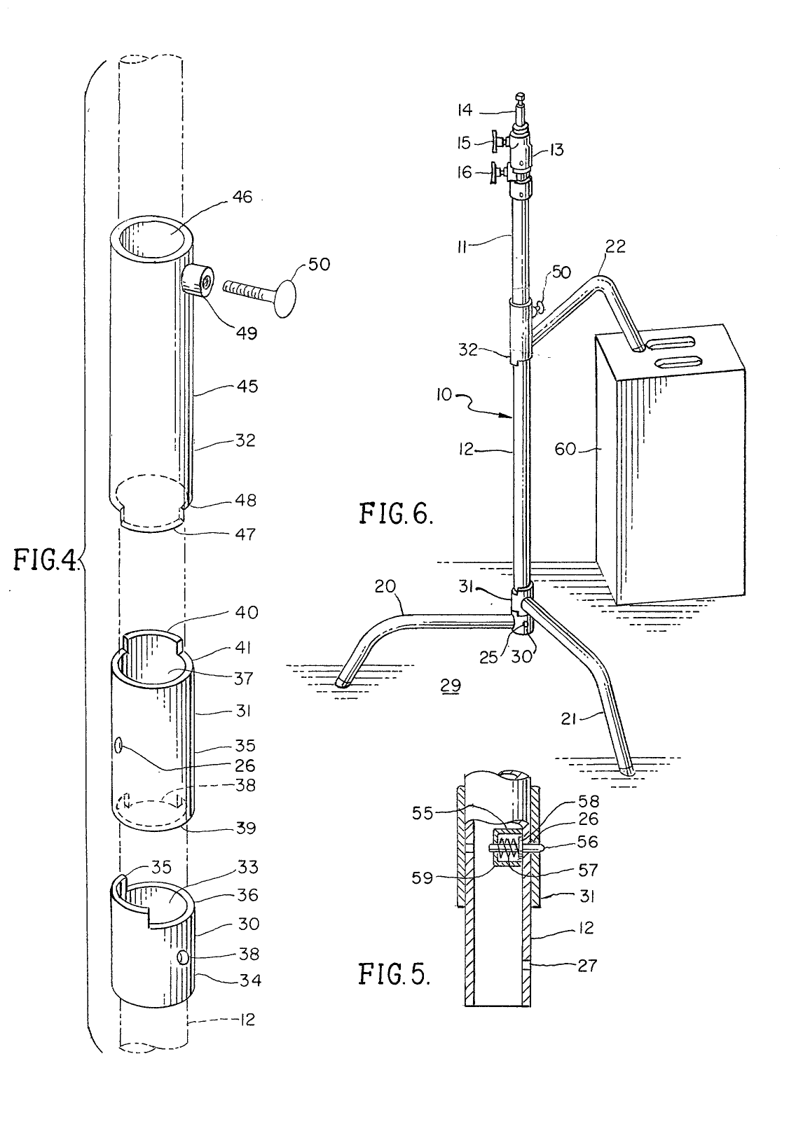

The structure of positioning sleeves 30, 31 and 32 may be best seen by reference to FIG. 4. Lower positioning sleeve comprises a substantially cylindrical member 34 having a central bore 33 longitudinally disposed therethrough. Bore 33 is adapted to be slidably disposed upon base shaft 12 and is secured to the lower terminus of base shaft 12. The upper end of lower positioning sleeve 30 is circumferentially divided into an engagement sector 35 and a receiving sector 36. Relative to the longitudinal axis of base shaft 12 and lower positioning sleeve 30, engagement sector 35 constitutes 1200 of arc. Receiving sector 36 is defined by a complementary 240° of arc. As can be best seen in FIG. 2, lower positioning sleeve 30 is secured at the lower terminus of base shaft 12. A threaded aperture 38 is disposed through cylindrical member 34. A mating threaded aperture 27 is disposed in base shaft 12 and is adapted to be aligned with threaded aperture 38. Lower positioning sleeve 30 is secured to base shaft 12 through the use of a set screw 25. It is understood other conventional means for attaching adjacent surfaces may be used such as rivets. To secure lower positioning sleeve relative to base shaft 12, set screw or rivet 25 is urged inwardly until it engages aperture 27 in base shaft 12.

Center positioning sleeve 31 is constructed of a cylindrical member 35 having a central bore 37 disposed therethrough along its longitudinal axis. Center positioning sleeve 31 is adapted to be slidably coupled about base shaft 12, but be in frictional engagement therewith. As will be explained in detail hereinbelow, although center positioning sleeve 31 is rotatable about base shaft 12, it may be locked in place when in the open position to provide stability for supporting accessories without the need of a downward locking force.

The lower terminus of center positioning sleeve 31 is formed into an engagement sector 38 and a receiving sector 39. Like engagement sector 35 of lower positioning sleeve 30, engagement sector 38 comprises 120° of arc relative to the longitudinal axis. Receiving sector 39 encompasses 240° of arc relative to the longitudinal axis. The upper terminus of center positioning sleeve 31 is formed into engagement sector 40 and receiving sector 41. Like the lower terminus, engagement sector 40 encompasses 120° of arc relative to the longitudinal axis, the receiving sector 41 encompassing 240° of arc.

The construction of upper positioning sleeve 32 is similar to lower positioning sleeve 30 and center positioning sleeve 31. Upper positioning sleeve 32 is constructed of a cylindrical member 45 and has a central bore 46 disposed therethrough along the longitudinal axis. The lower terminus of upper positioning sleeve 32 is formed into an engagement sector 47 and a receiving sector 48. Engagement sector 47 comprises 120° of arc relative to the longitudinal axis, receiving sector 48 comprising 240° of arc. The present invention equipment support stand is usable even where it must be placed adjacent to obstruction such as that shown in FIG. 6. To accomplish this objective, upper positioning sleeve 32 may be secured to base shaft 12 in a position which is spaced from center positioning sleeve 31. As can be seen in FIG. 4, a threaded receiver 49 is disposed through the cylindrical member 45 of upper positioning sleeve 32. Threaded locking member 50 engages threaded receiver 49 and is adapted to impose pressure on base shaft 12 to position upper positioning sleeve 32 at a desired position along the longitudinal axis of base shaft 12.

As stated hereinabove, an objective of the present invention is to provide means whereby center positioning sleeve 32 may be secured in place in its open position in order to stabilize the equipment support apparatus. Referring now to FIG. 5, the locking apparatus used to maintain center positioning sleeve 31 in place can be best seen, the locking apparatus being generally designated by the reference numeral 55. Locking apparatus 55 provides a displaceable locking pin 56 which is adapted to be disposed within aperture 26 of center positioning sleeve 31. In the preferred embodiment, a resilient force is exerted by helical spring 57 between flange 58 and housing 59. When locking pin 56 is disposed into aperture 26, center positioning sleeve 31 will be locked into its open position as shown in FIG. 1.

An objective of the present invention is to permit the support legs 20, 21 and 22 to rotate about base shaft 12 between the open or active position (FIG. 1) and the storage position (FIG. 2). To meet this objective, sleeves 30, 31 and 32 are adapted to lie in axial abutment with one another. Engagement sector 35 and receiving sector 36 of lower positioning sleeve 30 are adapted to engage receiving sector 39 and engagement sector 38, respectively, of center positioning sleeve 31. In a like manner, engagement sector 40 and receiving sector 41 of center positioning sleeve 30 are adapted to engage receiving sector 48 and engagement sector 47, respectively, of upper positioning sleeve 32. As shown in FIGS. 1 and 2, outer positioning sleeve 31 and upper positioning sleeve 32 are able to rotate about base shaft 12 relative to center positioning sleeve 30 a full 120° of arc. Since the angular rotation between the positioning sleeves 30, 31 and 32 are fully determined by the engagement and receiving surfaces of the positioning sleeves 30, 31 and 32, the present invention equipment support stand can efficiently be placed in the open position (FIG. 1) or storage position (FIG. 2), in an efficient manner which is superior to those disclosed in the prior art.

FIG. 1 illustrates the present invention equipment support stand in the conventional, open position. Support legs 20, 21 and 22 are each separated from adjacent support legs by 120° of arc. Under these conditions, positioning sleeves 30, 31 and 32 are in axial abutment with one another. To stabilize the position of positioning sleeves 30, 31 and 32 in the position shown in FIG. 1, upper positioning sleeve 32 is in axial abutment with the upper terminus 40 of center positioning sleeve 31. Threaded locking member 50 is engaged within receiver 49 of upper positioning sleeve 32 and bears against the outer surface of base shaft 12. Releasing locking member 50 will release the axial force on positioning sleeves 30, 31 and 32 and allow them to be rotated relative to one another until co-planar as shown in FIG. 2.

The structure of the present invention equipment support stand provides the flexibility to use the stand under difficult conditions. As can be seen in FIGS. 1, 2 and 6, the distance between support legs 20, 21 and 22 permit the placement of the equipment stand 10 to vary in order to compensate for the height of a variety of obstacles. FIG. 6 illustrates the use of the present invention equipment support stand 10 where an obstacle 60 either creates limited space for placement of the stand or necessitates greater flexibility to provide needed support. In FIG. 6, lower support leg 20 rests upon the support surface 29. By releasing locking member 50, upper positioning sleeve 32 may be urged upwardly toward the upper end of base shaft 12. Upper positioning leg 22 is braced against obstacle 60 thereby providing a stable base in combination with the contact between support legs 20 and 21 with supporting surface 29. As stated previously, one of the problems inherent in the devices disclosed by the prior art relates to inadvertent dislodgment of the support stand which could result from the displacement of a support leg. In the present invention, when center positioning sleeve 31 is in its open position as shown in FIG. 6, it will be locked in place thereby precluding any change in relative position between lower support leg 20 and center support leg 21. As a result, even when upper support leg 22 has been elevated in the manner shown in FIG. 6, any inadvertent force or pressure on the support stand will not dislodge or inadvertently displace support legs 20 and 21.

I claim:

1. An equipment support stand for mounting and positioning photographic, motion picture and video accessories comprising:
(a) A riser having an upper and lower end;
(b) A lower supporting member secured to the lower end of said riser;
(c) A center supporting member rotatable coupled about said riser in abutment with said lower supporting member intermediate said lower support member and the upper end of said riser;
(d) Locking means coupled to said riser for resiliently securing said center supporting member in a position arcuately displaced from said lower support member; and
(e) An upper supporting member rotatable coupled about said riser in abutment with the center supporting member intermediate the center supporting member and the upper end of said riser, said center support member and upper support member being rotatable relative to said lower support member between a coplanar position and equiangular displacement about said riser.

2. An equipment support stand as defined in claim 1 wherein said riser comprises a cylindrical base shaft.

3. An equipment support stand as defined in claim 2 wherein said lower support member comprises an elongated support leg extending into a cylindrical, lower positioning sleeve adapted to be secured to the base shaft and having upper and lower axial ends, said upper axial end having contiguous, complementary engagement and receiving surfaces disposed along the circumference thereof, and securing means for fixing the position of said lower positioning sleeve relative to said base shaft being disposed through said sleeve.

4. An equipment support stand as defined in claim 3 wherein said center supporting member comprises an elongated support leg extending into a cylindrical center positioning sleeve coupled about the base shaft in axial abutment with the upper axial end of said lower positioning sleeve and having upper and lower axial ends, each having contiguous, complementary engagement and receiving surfaces disposed along the circumference thereof, the engagement and receiving surfaces of the lower axial end of said center positioning sleeve being in communication with the receiving and engagement surfaces respectively of the lower positioning sleeve whereby the angular displacement between said lower and center positioning sleeves is determined.

5. An equipment support stand as defined in claim 4 wherein said upper support member comprises an elongated support leg extending into a cylindrical, upper positioning sleeve coupled about the base shaft in axial abutment with the upper axial end of said center positioning sleeve and having upper and lower axial ends, the lower axial end having contiguous, complementary engagement and receiving surfaces disposed along the circumference thereof, the engagement and receiving surfaces being in communication with the receiving and engagement surfaces respectively of the upper axial end of said center positioning sleeve whereby the angular displacement between said upper and mid-positioning sleeves is determined.

6. An equipment support stand as defined in claim 5 wherein the engagement and receiving surfaces of said lower, upper and mid-positioning sleeves radially extend 120 degrees of arc and 240 degrees of arc respectively.

7. An equipment support stand as defined in claim 5 wherein said upper positioning sleeve further includes locking means coupled thereto for securing said upper positioning means along said riser in spaced relation to said center positioning sleeve.

8. An equipment support stand as defined in claim 1 wherein said riser comprises a plurality of telescoping, annularly disposed cylindrical shafts.
